(19) United States
(12) Patent Application Publication
(10) Pub. No.: US 2005/0284359 A1
(43) Pub. Date: Dec. 29, 2005

(54) Charge restrained wafer of piezoelectric oxide single crystal, and charge restraining method and apparatus for piezoelectric oxide single crystal

(75) Inventors: Kazutoshi Hotta, Seto City (JP); Kazuya Kanno, Seto City (JP); Daisaku Miyagawa, Seto City (JP); Masato Kurachi, Seto City (JP); Takeji Sasamata, Seto City (JP); Ietaka Sahashi, Seto City (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: YAMAJU CERAMICS CO., LTD, Owariasahi City (JP)

(21) Appl. No.: 11/115,119

(22) Filed: Apr. 27, 2005

(30) Foreign Application Priority Data
Apr. 27, 2004 (JP) 2004-131733(PAT.)

(51) Int. Cl. C01G 31/02

(52) U.S. Cl. 117/3; 423/594.8; 252/62.9 R; 117/1; 117/2

(57) ABSTRACT

To provide a wafer, made from a lithium tantalate single crystal or a lithium niobate single crystal, wafer which is charge restrained without impairing the piezoelectricity. Moreover, to provide a processing method and a processing apparatus therefor. It is characterized in that a wafer 50, made from a lithium tantalate single crystal or a lithium niobate single crystal, and a reducing agent 60, including an alkali metal or an alkali metal compound, are accommodated in a processing tank 2, and the inside of the processing tank 2 is held at a temperature of from 200° C. or more to less than a Curie temperature of the single crystal under decompression, thereby reducing the wafer 50.

### BACKGROUND OF THE INVENTION

1. Field of the Invention

The present invention relates to a charge restrained wafer of a piezoelectric oxide single crystal, wafer which is used as a piezoelectric substrate, and the like, for elastic surface acoustic wave filters, a charge restraining method for a piezoelectric oxide single crystal, and a charge restraining apparatus therefor.

2. Description of the Related Art

A lithium tantalate (LiTaO₃) single crystal and a lithium niobate (LiNbO₃) single crystal have been known as piezoelectric oxide single crystals, and have been used in piezoelectric substrates, and the like, for elastic surface acoustic wave filters (SAW filters). Moreover, both single crystals have been also used in applied optical products, such as optical modulators and wavelength converter devices, which are basic component parts for large-capacity high-speed communication networks, as nonlinear optical crystals. Both single crystals have such characteristics that the pyroelectric coefficient is large and the resistance is high. Accordingly, electric charges are generated on their surfaces by a slight temperature change. And, once generated electric charges accumulate thereon so that the charged state continues unless carrying out de-charging from the outside.

For example, an optical modulator cause light to transmit in a light guide or the inside of single crystal directly. When modulating light, it is controlled by applying an electric field to single crystal. In this instance, even when the electric field is turned off, if an electric field remains on the surface of single crystal, light has been modulated by a remaining electric charge. Moreover, an electric charge is generated on the surface by a temperature change, and accordingly the refractive index has changed.

On the other hand, in the manufacturing steps of elastic surface acoustic wave filters, there are processes, which accompany the temperature changes of piezoelectric substrate's temperature, such as the formation of electrode thin films onto the surface of piezoelectric substrate and pre-baking and post-baking in photolithography. Accordingly, when using a lithium tantalate single crystal or a lithium niobate single crystal as a piezoelectric substrate, the generation of static electricity on piezoelectric substrate matters in the manufacturing processes of elastic surface acoustic wave filters.

When a piezoelectric substrate is charged, a static electricity discharge occurs within the piezoelectric substrate, and becomes the cause of cracks or breakage. Further, there is a fear that electrodes formed on a piezoelectric substrate might be short-circuited by static electricity. Furthermore, fine metallic powders, dust, dirt, and the like, which generates in the manufacturing steps, are attracted onto the surface of a piezoelectric substrate by static electricity to short-circuit its electrodes, and moreover there is a fear that the electrodes are turned into exposed states to be destroyed.

Considering such charging of piezoelectric substrates, various countermeasures are taken in manufacturing elastic surface acoustic wave filters. For example, it is possible to name disposing de-charging equipment, such as ionizers for neutralizing the electric charges on the surfaces of piezoelectric substrates, and disposing incidental equipment, such as particle counters or microscopes for measuring dust, and the like. Moreover, in the manufacturing steps of elastic surface acoustic wave filters, it has been carried out to add a conductive film forming step, in which a conductive film for the purpose of de-charging is formed on a rear surface of a piezoelectric substrate in advance, before forming electrode thin films, or a re-cleaning step after forming electrode thin films.

Moreover, in view of inhibiting lithium tantalate single crystals and lithium niobate single crystals themselves from charging, in Patent Literature No. 1, there is disclosed a method in which a wafer made from these single crystals is heat treated in a reducing atmosphere. Moreover, in Patent Literature No. 2, there is disclosed a method in which a metal is diffused in the same wafer.

Patent Literature No. 1: Japanese Unexamined Patent Publication (KOKAI) No. 11-92,147

Patent Literature No. 2: Japanese Unexamined Patent Publication (KOKAI) No. 2004-35,396

### SUMMARY OF THE INVENTION

For example, the Curie point of lithium tantalate single crystal is about 603° C. Accordingly, when the lithium tantalate single crystal is exposed to high temperatures of more than 600° C., there is a fear of losing its piezoelectricity. That is, when considering the piezoelectricity of lithium tantalate single crystal, it is not possible to carry out heat treating at a high temperature. On the other hand, even when a wafer made from a lithium tantalate single crystal is heat treated at a relatively low temperature of from 400 to 600° C. approximately, nothing but only the surface of the wafer is reduced. That is, by the heat treatment in a reducing gas set forth in above Patent Literature No. 1, it is difficult to inhibit charging without impairing the piezoelectricity of lithium tantalate single crystal.

Moreover, as set forth in Patent Literature No. 2, when diffusing a metal, such as zinc, in a single crystal, the mixing of the other elements changes the Curie point so that the piezoelectricity has changed. In addition, since the metal deposits on the wafer, it is needed to remove the deposits after the treatment. Furthermore, when employing a metal with violent reactivity, it becomes impossible to adjust the reduction degree.

The present invention has been performed in view of such circumstances, and it is an assignment to provide a charge restrained wafer made from a lithium tantalate single crystal or a lithium niobate single crystal without impairing the piezoelectricity. Moreover, it is an assignment to provide a processing method which can restrain the charging of lithium tantalate single crystal or lithium niobate single crystal. In addition, it is an assignment to provide a processing apparatus which can carry out the processing method simply and easily.

Means for Solving the Assignments
(1) A charge restrained wafer according to the present invention, wafer which is made from a lithium tantalate single crystal or a lithium niobate single crystal, is characterized in that it exhibits a bulk resistivity of from 1.0×10¹⁰ Ω·cm or more to 9.0×10¹² Ω·cm or less at a superficial portion and a central portion.

The charge restrained wafer, made from a lithium tantalate single crystal (hereinafter referred to as an “LT single crystal” wherever appropriate) or a lithium niobate single crystal (hereinafter referred to as an “LN single crystal” wherever appropriate), is such that the bulk resistivity is from 1.0×10¹⁰ Ω·cm or more to 9.0×10¹² Ω·cm or less not only at the superficial portion but also deep down to the inside.

The bulk resistivity of an LT single crystal, for instance, which is not charge restrained, is usually from 1.0×10¹⁴ Ω·cm or more to 9.0×10¹⁵ Ω·cm or less. The present wafer is charge restrained so that the bulk resistivity falls in the aforementioned range from the surface to deep down to the inside.

By letting the bulk resistivity fall in the aforementioned range, the charge resistance is restrained fully, and it has strength and hardness which are sufficient for polishing.

Moreover, the bulk resistivity can desirably be uniform in the depth-wise direction. By letting the bulk resistivity fall in the aforementioned range from the surface to deep down to the inside, it does not come under the influence of portions whose bulk resistivity differs. Moreover, by being uniform in the depth-wise direction, even when inner surfaces are exposed to the surface by cutting, for example, they do not hinder the transfer of electric charges nor induce sparks.

Moreover, the bulk resistivity can desirably be uniform within a processed surface. For example, when using the wafer as a substrate, several thousands of devices are installed on the substrate. No characteristic fluctuations, which affect the devices, should be present in the substrate. The bulk resistivity uniformity within a processed surface becomes important therefor as well.

Since the present charge restrained wafer is less likely to be charged, it is easy to handle and safe.

Moreover, when manufacturing an elastic surface acoustic wave filter using the same wafer as a piezoelectric substrate, it becomes unnecessary to dispose de-charging equipment so that the cost can be reduced remarkably. In addition, since a manufacturing process for de-charging becomes unnecessary as well, the productivity improves. Moreover, by making a piezoelectric substrate from the same wafer, it is possible to constitute an elastic surface acoustic wave filter, which causes defects resulting from static electricity less, in storage as well as in service.

In addition, when employing the same wafer as applied optical products, such as optical modulators and wavelength converter devices, the modulations resulting from residual electric charges, and the refractive index changes resulting from the generation of electric charges are inhibited. Accordingly, the reliability of applied optical products improves.
(2) Moreover, in the present charge restrained wafer, wafer which is made from a lithium tantalate single crystal or a lithium niobate single crystal, a change in Curie temperatures at a superficial layer of the wafer before a charge restraining process and after the process can desirably fall within ±3° C.

It is furthermore preferable that the change in Curie temperatures can desirably fall within ±0.5° C.

The Curie temperature represents the phase transition temperature of single crystal.

The piezoelectric characteristic of single crystal depends on the compositional ratio of lithium to tantalum or niobium. These compositional ratios are expressed by the concentrations of lithium. When the lithium concentration changes even very slightly, the piezoelectric characteristic changes.

In the aforementioned single crystals, the Curie temperature correlates with the lithium concentration, when the lithium concentration changes by 0.025 mol %, the Curie temperature changes by 1° C. Moreover, when an impurity other than the elements constituting the single crystals is doped, the Curie temperature changes.

For example, the condition required as for a piezoelectric substrate of high-frequency SAW filter is to control the lithium concentration change resulting from a charge restraining process within ±0.075 mol %. The Curie temperature change is within ±3° C.

As described above, the Curie temperature, which changes by being subjected to a charge restraining process, represents that the piezoelectric characteristics of the single crystals change. Therefore, it is desirable that the Curie temperature does not change at all by a charge restraining process.
(3) In the present charge restrained wafer, a Curie temperature difference between a superficial layer of the charge restrained wafer and an inner part thereof can desirably fall within ±3° C. It is furthermore preferable that the Curie temperature difference can fall desirably ±0.5° C.

As described above, the Curie temperature, which changes by being subjected to a charge restraining process, represents that the piezoelectric characteristics of the single crystals change. No substantial Curie temperature difference between the superficial layer of the charge restrained wafer and an inner part thereof indicates that the piezoelectric characteristics of the superficial layer and inner part hardly differ.
(4) A method for charge restraining a piezoelectric oxide single crystal according to the present invention is characterized in that it comprises: accommodating a wafer, made from a lithium tantalate single crystal or a lithium niobate single crystal, and a reducing agent, including an alkali metal or an alkali metal compound, in a processing apparatus; and reducing the wafer by holding the inside of the processing apparatus at a temperature of from 200° C. or more to less than a Curie temperature of the single crystal under decompression.

In the present method for charge restraining, a wafer, made from a lithium tantalate single crystal or a lithium niobate single crystal, is heated to and held at a predetermined temperature under decompression, together with a reducing agent. An alkali metal or alkali metal compound, constituting the reducing agent, evaporates under a predetermined condition, and turns into a vapor with high reducing power. When being exposed to this vapor, the wafer is reduced sequentially from the surface. And, by keeping supplying the reducing agent, it is possible to continuously develop the reducing reaction, and accordingly it is possible to uniformly reduce the entire wafer. Moreover, in accordance with the present charge restraining method, the productivity improves because the processing time can be reduced to 1/10 or less than conventionally.

The resistance of the wafer is decreased by reduction. Accordingly, the reduced wafer is less likely to produce electric charges even when the temperature changes. Moreover, even if electric charges generate on the wafer's surface tentatively, they self-neutralize quickly, and consequently it is possible to remove the electric charges. Thus, in accordance with the present charge restraining method, it is possible to effectively inhibit the wafer, made from an LT single crystal or an LN single crystal, from charging.

In the present charge restraining method, the vapor of an alkali metal or alkali metal compound whose reaction is relatively gentle is used as the reducing agent. Accordingly, it is easy to handle the reducing agent, and the safety is high. Moreover, by adequately adjusting the type of reducing agent, the usage amount, the disposing form, the vacuum degree within a processing tank, the temperature and the processing time, it is possible to control the reduction degree of the wafer.

Since the wafer processed by the present charge restraining method is less likely to be charged, it can be handled with ease and is safe. Moreover, when manufacturing an elastic surface acoustic wave filter using the same wafer as a piezoelectric substrate, it becomes unnecessary to dispose de-charging equipment so that the cost can be reduced remarkably. In addition, since a manufacturing process for de-charging becomes unnecessary as well, the productivity improves. Moreover, by making a piezoelectric substrate from the same wafer, it is possible to constitute an elastic surface acoustic wave filter, which causes defects resulting from static electricity less, in storage as well as in service. In addition, when employing the same wafer as applied optical products, such as optical modulators and wavelength converter devices, the modulations resulting from residual electric charges, and the refractive index changes resulting from the generation of electric charges are inhibited. Accordingly, the reliability of applied optical products improves.
(5) In the present charge restraining method, the reduction of the wafer can desirably be carried out under decompression of from 133×10⁻¹ to 133×10⁻⁷ Pa. By decompressing the inside of a processing tank, it is possible to turn an alkali metal compound into a vapor with high reducing power even at relatively low temperatures.
(6) The oxygen in an LT single crystal or an LN single crystal exhibits a high bonding force with lithium. Accordingly, in the conventional reduction treatments, the oxygen is likely to be emitted in a state being bonded with lithium, that is, in a state of lithium oxide. As a result, the lithium concentration in the single crystals decreases to change the lithium:tantalum (niobium) ratio so that there is a fear of changing the piezoelectricity.

Therefore, an alkali metal or alkali metal compound used as the reducing agent can desirably be made into metallic lithium or lithium compound. Thus, it is possible to react the oxygen in the single crystals with lithium atoms supplied from the reducing agent. Accordingly, the lithium atoms in the single crystals are less likely to be emitted. Consequently, the lithium:tantalum (niobium) ratio does not change so that the piezoelectricity does not change. Moreover, since lithium is a constituent element of the single crystals, there are no worries about the pollution resulting from the mixing of the other elements.
(7) In the present charge restraining method, it is possible to employ an embodiment in which the reducing agent comprising an alkali metal or alkali metal compound is used; and the reduction of the wafer is carried out by disposing the reducing agent and the wafer separately, or by burying the wafer in the reducing agent. In the present embodiment, it is possible to use powders, pellets and the like of alkali metals or alkali metal compounds as the reducing agent. Since it is possible to use powders, pellets and the like of alkali metals or alkali metal compounds as they are, the present embodiment can be carried out with ease. Moreover, when burying the wafer in the reducing agent, the reducing agent contacts with the surfaces of the wafer with a high concentration. Accordingly, it is possible to furthermore facilitate the reduction of the wafer.
(8) Moreover, when employing an alkali metal solution or an alkali metal compound solution, in which the alkali metal or the alkali metal compound is dissolved or dispersed in a solvent, is used as the reducing agent, it is possible to employ an embodiment in which the reduction of the wafer is carried out by disposing the reducing agent and the wafer separately, or by immersing the wafer into the reducing agent, or by painting the reducing agent onto a surface of the wafer.

In the present embodiment, an alkali metal solution or alkali metal compound solution is used as the reducing agent. For example, an alkali metal solution or an alkali metal compound solution, in which an alkali metal or alkali metal compound is dissolved or dispersed in an organic solvent, generates an organic gas when being heated. By filling up a vapor of an alkali metal or alkali metal compound into this organic gas, it is possible to enhance the reactivity between the alkali metal and the wafer. Thus, the entire wafer is reduced evenly. Moreover, when immersing the wafer into the same solution, or when painting the same solution onto a surface of the wafer, the reducing agent contacts with the surface of the wafer with a high concentration. Accordingly, it is possible to furthermore facilitate the reduction of the wafer.
(9) A charge restraining apparatus for a piezoelectric oxide single crystal according to the present invention comprises: a processing tank for accommodating a wafer, made from a lithium tantalate single crystal or a lithium niobate single crystal, and a reducing agent, including an alkali metal or an alkali metal compound, therein; means for heating the inside of the processing tank to a temperature of from 200° C. or more to less than a Curie temperature of the single crystal; and means for decompressing the inside of the processing tank.

In the present charge restraining apparatus, the wafer and reducing agent in the processing tank are heated by the heating means. Moreover, the inside of the processing tank is decompressed by the decompressing means. Thus, in accordance with the present charge restraining apparatus, it is possible to carry out the aforementioned present charge restraining method easily and simply. Moreover, since the vapor of an alkali metal or alkali metal compound whose reaction is relatively gentle is used as the reducing agent, the present charge restraining apparatus is of high safety. Note that preferred embodiments of the present charge restraining apparatus are compliant with those of the above-described present charge restraining method.

In the present charge restraining method, the wafer is reduced under predetermined conditions, using the reducing agent. Since the entire wafer can be reduced sufficiently, it is possible to effectively inhibit the wafer from charging. Moreover, by adequately adjusting the reducing agent, the processing conditions, and the like, it is possible to control the reduction degree of the wafer.

The present charge restraining apparatus comprises the processing tank for accommodating the wafer and reducing agent therein, the heating means, and the decompressing means. In accordance with the present charge restraining apparatus, it is possible to carry out the aforementioned present charge restraining method easily and simply.

### BRIEF DESCRIPTION OF THE DRAWINGS

A more complete appreciation of the present invention becomes better understood by reference to the following detailed description when considered in connection with the accompanying drawings and detailed specification, all of which forms a part of the disclosure. Hereinafter, the drawings are described briefly.

FIG. 1 is a schematic diagram of a charge restraining apparatus, a first embodiment according to the present invention.

FIG. 2 is a model diagram for illustrating how wafers are disposed in a processing tank (first embodiment).

FIG. 3 is a model diagram for illustrating how wafers and a reducing agent are disposed in a processing tank (second embodiment).

FIG. 4 is a graph for illustrating a relationship between processing temperature and bulk resistivity (Example Nos. 11 through 15).

FIG. 5 is a graph for illustrating a relationship between processing temperature and bulk resistivity (Example Nos. 16 and 17).

FIG. 6 is a graph for illustrating a relationship between processing pressure and bulk resistivity (Example Nos. 21 through 22).

FIG. 7 is a graph for illustrating a relationship between processing time and bulk resistivity (Example Nos. 31 through 34).

FIG. 8 is a graph for illustrating a bulk resistivity change in the thickness-wise direction of a wafer (Test Sample No. 10).

FIG. 9 is an explanatory diagram for illustrating transmissivity measurement points in a wafer (Test Sample No. 10).

### DETAILED DESCRIPTION OF THE PREFERRED EMBODIMENTS

Hereinafter, embodiments of a charge restraining apparatus according to the present invention will be described in detail. Moreover, while describing embodiments of the present charge restraining apparatus, charge restraining methods according to the present invention will be described simultaneously. Note that a piezoelectric-oxide-single-crystal wafer according to the present invention, which is charge restrained, will be described in examples.

(1) First Embodiment

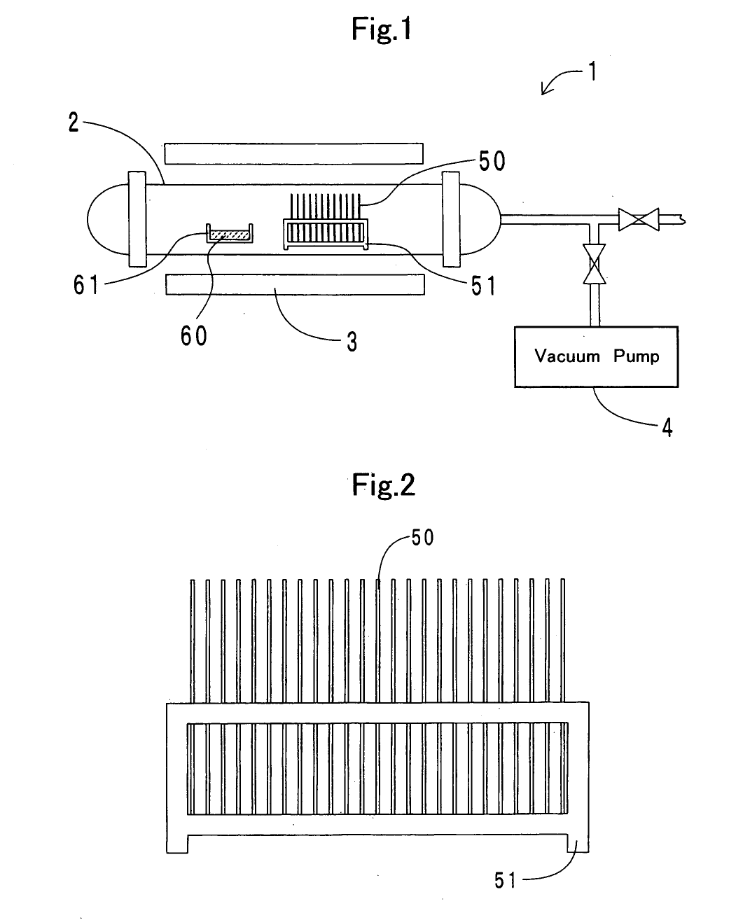

First, an arrangement of a charge restraining apparatus, the present embodiment, will be described. In FIG. 1, an outline of the charge restraining apparatus is illustrated. Moreover, in FIG. 2, how wafers are disposed in a processing tank is illustrated with a model. As illustrated in FIG. 1, a charge restraining apparatus 1 comprises a processing tank 2, a heater 3, and a vacuum pump 4.

The processing tank 2 is made of quartz glass. One of the opposite ends of the processing tank 2 is connected with piping. Through the connected piping, the evacuation within the processing tank 2 is carried out. In the processing tank 2, wafers 50 and a lithium chloride powder 60 are accommodated.

The wafers 50 are supported by a wafer cassette case 51 made of quarts. The wafers 50 are composed of 42° Y-Xcut LT single crystal. The diameter of the wafers 50 is 4 inches (about 10.16 cm), and the thickness is 0.5 mm. The wafers 50 are disposed in a quantity of 50 pieces at intervals of about 5 mm.

The lithium chloride powder 60 is disposed, independently of the wafers 50, within a petri dish 61 made of quartz glass. The lithium chloride powder 60 is the reducing agent in the present invention. The amount of lithium chloride powder 60 to be accommodated is 100 g.

The heater 3 is disposed so as to cover around the processing tank 2. The heater 3 is included in the heating means constituting the present charge restraining apparatus.

The vacuum pump 4 is connected with the processing tank 2 by way of the piping. The vacuum pump 4 evacuates gases within the processing tank 2 to vacuumize the inside of the processing tank 2. The vacuum pump 4 is included in the decompressing means constituting the present charge restraining apparatus.

Next, an example flow of a charge restraining treatment by the charge restraining apparatus of the present embodiment will be described. First, by the vacuum pump 4, the inside of the processing tank 2 is turned into a vacuum atmosphere of 1.33 Pa approximately. Next, by the heater 3, the processing tank 2 is heated to raise the temperature within the processing tank 2 to 550° C. for 3 hours. When the temperature within the processing tank 2 reaches 550° C., it is held in the state for 18 hours. Thereafter, the heater 3 is turned off to naturally cool the inside of the processing tank 2.

In accordance with the present embodiment, the following advantages set forth below can be obtained. That is, in the present embodiment, the lithium chloride powder 60 was used as the reducing agent. Accordingly, it is possible to react the oxygen in the LT single crystal with the lithium atoms with are supplied from the reducing agent. Consequently, the lithium atoms in the LT single crystal are less likely to be released. Therefore, the lithium:tantalum ratio in the LT single crystal does not change so that the piezoelectricity does not change. Moreover, since lithium is a constituent component of the LT single crystal, there is no fear of contamination resulting from the mixing other elements. In addition, the lithium chloride powder 60 is easy to handle so that it is possible to carry out the charge restraining treatment safely.

In the present embodiment, the lithium chloride powder 60 was used in an amount of 100 g. According to a preparatory experiment, the amount of lithium chloride powder consumed under the aforementioned processing conditions (550° C. and 18 hours) is about 40 g. Accordingly, in the present embodiment, it is possible to continuously develop the reduction reaction so that it is possible to uniformly reduce the entire wafers 50. As a result, it is possible to effectively restrain the charging of wafers 50.

In the present embodiment, since the inside of the processing tank 2 is turned into a vacuum atmosphere of 1.33 Pa approximately, the lithium chloride powder 60 is turned into a vapor with high reducing power. Accordingly, it is possible to carry out a reduction treatment at 550° C. so that it is possible to carry out the reduction of the entire wafers 50 without impairing the piezoelectricity.

(2) Second Embodiment

The difference between a second embodiment and the first embodiment is that the type of the reducing agent and the disposing form were altered. Since the other arrangements are identical with those of the first embodiment, the differences will be described herein.

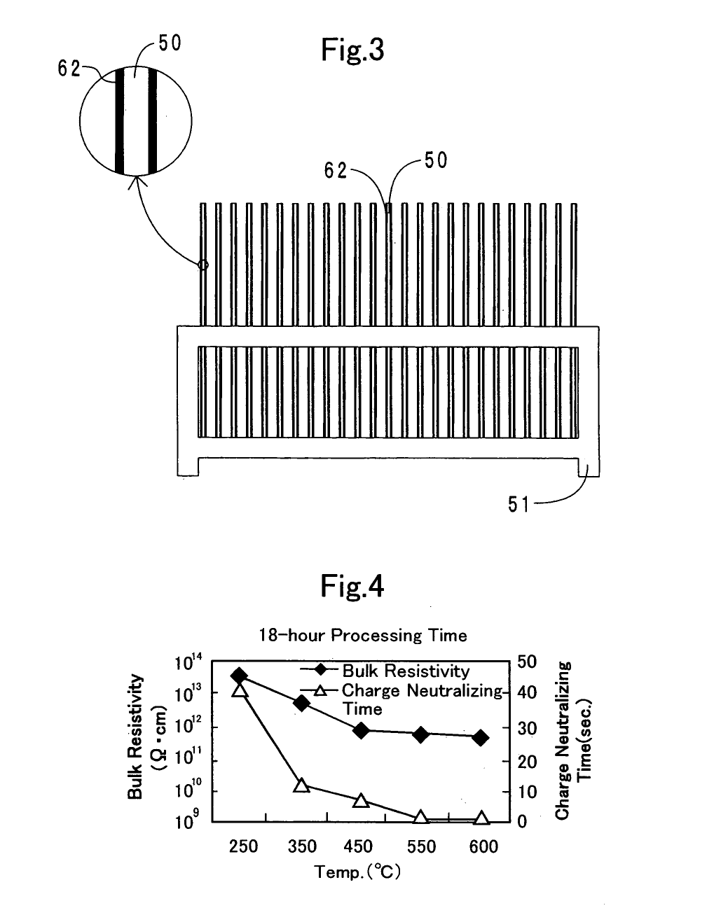

In FIG. 3, how wafers and a reducing agent are disposed in the present embodiment is illustrated with a model. In FIG. 3, component parts corresponding to those in FIG. 2 are designated with the same reference numerals. As illustrated in FIG. 3, the both opposite surfaces of wafers 50 are coated with a lithium carbonate solution 62 in which 100 g lithium carbonate powder is dissolved into polyvinyl alcohol. The lithium carbonate solution 62 is the reducing agent in the present invention. The coating of the wafers 50 was carried out by immersing the wafers 50 into the lithium carbonate solution 62, painting the lithium carbonate solution 62 onto the surfaces of wafers 50, and thereafter drying them at room temperature and 200° C. Within a processing tank 2, only a wafer cassette case 51, which holds the wafers 50 therein, is disposed. And, a charge restraining treatment is carried out in the same manner as the first embodiment.

In accordance with the present embodiment, the following advantages set forth below can be obtained, in addition to the operations and advantages described in the first embodiment. That is, in the present embodiment, the lithium carbonate solution 62 was used as the reducing agent. The lithium carbonate solution 62 generates organic gases, upon being heated. By filling up the vapor of lithium carbonate into the organic gases, the reduction of wafers 50 is facilitated. Additionally, since the lithium carbonate solution 62 is disposed to contact with the surfaces of wafers 50, the reduction of wafers 50 are furthermore facilitated.

(3) Other Embodiments

So far, a few embodiments of the charge restraining apparatus according to the present invention have been described. However, embodiments of the present charge restraining apparatus are not limited to the aforementioned embodiments, but can be carried out in various forms subjected to various changes and modifications based on the knowledge of one of ordinary skill in the art.

For example, in the aforementioned embodiments, the charge restraining treatments are carried out onto the wafers made from an LT single crystal. However, wafers made from an LN single crystal can be processed, moreover, wafers made from the respective single crystals can be processed simultaneously. In addition, wafers made from an LT single crystal or LN single crystal with a metal, such as iron, added, can be processed. In this instance, as for the additive metal, it is possible to name iron, copper, manganese, molybdenum, cobalt, nickel, zinc, carbon, magnesium, titanium, tungsten, indium, tin, rare-earth elements, and the like. Moreover, the addition amount can be from 0.005% by weight or more to 1.00% by weight or less when the entire weight of single crystal is taken as 100% by weight. An LT crystal and so on with a metal, such as iron, added has a charge neutralizing characteristic for self-neutralizing surface charges and removing them. By reducing wafers made from such a single crystal, it is possible to more effectively inhibit the charging of wafers. Note that the shapes, polished states and so forth of using wafers are not limited in particular. For instance, it is advisable to use as-cut crystal blocks which are cut out of a single crystal to a predetermined thickness, moreover, it is possible to use such crystal blocks whose surfaces are mirror polished.

The types of alkali metal compound constituting the reducing agent are not limited to the aforementioned embodiments. For example, in the case of lithium compound, it is possible to use lithium hydroxide, lithium bromide, lithium nitrate, and the like, in addition to the lithium chloride and lithium carbonate used in the aforementioned embodiments. Moreover, it is advisable to use alkali metal compounds other than the lithium compounds, specifically, sodium compounds, such as sodium carbonate and sodium hydroxide, potassium compounds, such as potassium carbonate, potassium hydroxide and potassium chloride. It is advisable to use each of these alkali metal compounds independently, or it is advisable to use two or more of them combinedly.

In the first embodiment, the reducing agent and the wafers are disposed separately, however, the charge restraining treatment can be carried out while burying the wafers in the reducing agent. In this instance, it is advisable to embed an alkali metal compound powder in a processing tank under a predetermined condition, bury wafers in it, and carry out the charge restraining treatment.

Moreover, it is advisable to use a gas including an alkali metal compound as the reducing agent. In this instance, it is advisable to carry out the charge restraining treatment while introducing a gas including an alkali metal compound into a processing tank held under a predetermined condition. Alternatively, it is advisable to carry out the charge restraining treatment while supplying a gas including an alkali metal compound into a processing tank and evacuating it therefrom continuously.

When an alkali metal compound solution is used as the reducing agent like the second embodiment, it is desirable to use a liquid, which does not generate oxygen in vacuum atmospheres, as the solvent. For example, in addition to the aforementioned polyvinyl alcohol, organic solvents, such as glycerin which is readily available, are suitable. Moreover, when using an alkali metal compound solution as the reducing agent, it is advisable to make the concentration of alkali metal compound as high as possible, in view of furthermore promoting the reduction of wafers. In addition, when using an alkali metal compound solution, it is advisable to accommodate the same solution in a container and dispose it independently of wafers, or it is advisable to immerse wafers into the same solution.

In the aforementioned embodiments, the treatments were carried out in a vacuum atmosphere of 1.33 Pa approximately. However, the processing pressure is not limited in particular. The processing at pressures lower than 1.33 Pa, that is, under higher vacuum atmospheres, is suitable. Moreover, when turning the inside of a processing tank into a vacuum state, it is advisable to carry it out after substituting a high-purity inert gas for the inside of a processing tank. As for the inert gas, it is possible to use nitrogen, argon, and the like, for example.

Moreover, the processing time is not limited in particular, but can be determined appropriately while taking the processing temperature, and the like, into consideration. By thus adjusting the type of reducing agent, the using amount, the disposing form, the vacuum degree within processing tank, the temperature and the processing time, it is possible to control the reduction degree of wafers.

### EXPERIMENTAL EXAMPLES

(1) Charge Restraining Treatment by First Embodiment

By using the charge restraining apparatus according to the aforementioned first embodiment, various charge restraining treatments were carried out under the conditions set forth in Table 1 and Table 2 below. The charge restraining treatments were carried out in compliance with the flow of the charge restraining treatment according to the first embodiment. As set forth in Table 1, the charge restraining treatments, which were carried out at a processing pressure of 8.38×10⁻¹ Pa for 18-hour processing time but whose processing temperatures were varied, were labeled Example Nos. 11 through 15. Moreover, the charge restraining treatments, which were carried out at the same processing pressure for 6-hour processing time but whose processing temperatures were varied, were labeled Example Nos. 16 and 17. As set forth in Table 2, the charge restraining treatments, which were carried out at a processing temperature of 550° C. for 18-hour processing time but whose processing pressures were varied, were labeled Example Nos. 21 through 25. Note that, for comparison, charge restraining treatments, which were carried out without using the reducing agent, were labeled Comparative Example Nos. 11 through 15 and 21 through 23, depending on the respective conditions.

TABLE 1

| Reducing | Processing | Processing Temp. (° C.) | | | | |
|---|---|---|---|---|---|---|
| Agent | Time (hour) | 250 | 350 | 450 | 550 | 600 |
| Lithium | 18 | Ex. #11 | Ex. #12 | Ex. #13 | Ex. #14 | Ex. #15 |
| Chloride | | | | | | |
| Powder | | | | | | |
| None | 18 | | | Comp. | Comp. | Comp. |
| | | | | Ex. #11 | Ex. #12 | Ex. #13 |
| Lithium | 6 | | | Ex. #16 | Ex. #17 | |
| Chloride | | | | | | |
| Powder | | | | | | |
| None | 6 | | | Comp. | Comp. | |
| | | | | Ex. #14 | Ex. #15 | |

*Processing Pressure: 8.38 × 10⁻¹ Pa

TABLE 2

| | Processing Pressure (Pa) | | | | |
|---|---|---|---|---|---|
| | 133 × | 133 × | 133 × | 133 × | 133 × |
| Reducing Agent | 10⁻¹ | 10⁻² | 10⁻³ | 10⁻⁶ | 10⁻⁷ |
| Lithium | Ex. #21 | Ex. #22 | Ex. #23 | Ex. #24 | Ex. #25 |
| Chloride Powder | | | | | |
| None | | | Comp. Ex. | Comp. Ex. | Comp. Ex. |
| | | | #21 | #22 | #23 |

*Processing Temp.: 550° C., Processing Time: 18 hours

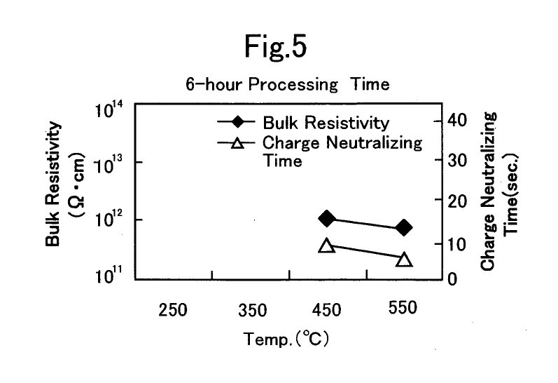

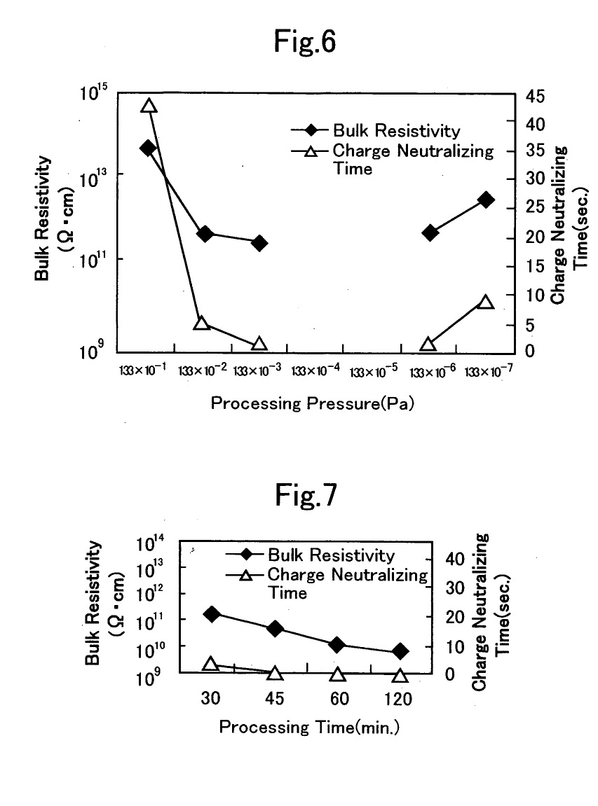

Regarding the respective wafers which were charge restrained, the bulk resistivity, and the transmissivity were measured. The bulk resistivity was measured using “DSM-8103” made by TOA DKK Co., Ltd. The transmissivity was measured using an ultraviolet-visible light spectrophotometer (“V570” made by NIHON BUNKOU Co., Ltd.). Moreover, the wafers were placed on a plate which was set up at 80±5° C., and the subsequent changes of surface voltage with time were measured. And, the times (charge neutralizing times) required for surface voltage to be 0 kv were measured. In Table 3 and Table 4, there are set forth the measurement results on the wafers, which were subjected to the respective charge restraining treatments according to examples and comparative examples, and on unprocessed wafers. Note that the surface voltages in Tables 3 and 4 are values immediately after the wafers were placed on the 80±5° C. plate. Moreover, in FIG. 4, there are illustrated relationships between the processing temperature and the bulk resistivity as well as the charge neutralizing time (18-hour processing time; Example Nos. 11 through 15). In FIG. 5, there are illustrated relationships between the processing temperature and the bulk resistivity as well as the charge neutralizing time (6-hour processing time; Example Nos. 16 and 17). In FIG. 6, there are illustrated relationships between the processing pressure and the bulk resistivity as well as the charge neutralizing time (Example Nos. 21 through 25).

TABLE 3

| | | | | | | Comp. Ex. | Comp. Ex. | Comp. Ex. |
|---|---|---|---|---|---|---|---|---|
| | Ex. #11 | Ex. #12 | Ex. #13 | Ex. #14 | Ex. #15 | #11 | #12 | #13 |
| Bulk | 3.8 × 10¹³ | 4.9 × 10¹² | 7.3 × 10¹¹ | 5.2 × 10¹¹ | 3.9 × 10¹¹ | 3.3 × 10¹⁴ | 2.3 × 10¹³ | 2.6 × 10¹³ |
| Resistivity | | | | | | | | |
| (Ω · cm) | | | | | | | | |
| Surface | 3.83 | 1.12 | 0.52 | 0.20 | 0.15 | 4.14 | 2.41 | 2.36 |
| Voltage (kV) | | | | | | | | |
| Charge | 42 | 11.7 | 6.8 | 1.0 | 0.5 | ∞ | 45 | 46 |
| Neutralizing | | | | | | | | |
| Time (sec.) | | | | | | | | |

| | Ex. #16 | Ex. #17 | Comp. Ex. #14 | Comp. Ex. #15 | Unprocessed |
|---|---|---|---|---|---|
| Bulk | 9.8 × 10¹¹ | 6.9 × 10¹¹ | 6.1 × 10¹⁴ | 8.9 × 10¹³ | 2.3 × 10¹⁵ |
| Resistivity | | | | | |
| (Ω · cm) | | | | | |
| Surface | 0.79 | 0.30 | 4.43 | 3.95 | 4.31 |
| Voltage (kV) | | | | | |
| Charge | 8.4 | 5.0 | ∞ | ∞ | ∞ |
| Neutralizing | | | | | |
| Time (sec.) | | | | | |

TABLE 4

| | | | | | | Comp. Ex. | Comp. Ex. | Comp. Ex. |
|---|---|---|---|---|---|---|---|---|
| | Ex. #21 | Ex. #22 | Ex. #23 | Ex. #24 | Ex. #25 | #21 | #22 | #23 |
| Bulk | 3.8 × 10¹⁴ | 4.5 × 10¹¹ | 3.3 × 10¹¹ | 5.2 × 10¹¹ | 3.5 × 10¹² | 3.3 × 10¹³ | 2.3 × 10¹³ | 2.6 × 10¹⁴ |
| Resistivity | | | | | | | | |
| (Ω · cm) | | | | | | | | |
| Surface | 4.1 | 0.41 | 0.16 | 0.20 | 0.7 | 2.34 | 1.5 | — |
| Voltage (kV) | | | | | | | | |
| Charge | ∞ | 4.2 | 0.9 | 1.0 | 8.7 | 45 | 19.7 | — |
| Neutralizing | | | | | | | | |
| Time (sec.) | | | | | | | | |

As set forth in Table 3, when comparing the wafers according to the examples with the wafers according to the comparative examples, wafers which were processed at the same temperature, the bulk resistivity and surface voltage were lowered and the charge neutralizing time was shortened in all of the wafers according to the examples. Moreover, it was confirmed that the transmissivity was also lowered, though it is not listed in Table 3. Thus, it is understood that the wafers were reduced efficiently by the reducing agent so that the charging was restrained. Moreover, as shown in FIG. 4 and FIG. 5, the higher the processing temperature was, the more the bulk resistivity of wafers was lowered and the more the charge neutralizing time was shorted. Similarly, the transmissivity and surface voltage were lowered as well. In addition, when comparing the processing times alone, the charge restraining effect was enhanced more for those which were processed for 18 hours. Thus, in accordance with the charge restraining treatment of the present invention, it was confirmed possible to effectively inhibit the charging of wafers. Additionally, by adjusting the processing temperature or processing time, it was confirmed possible to control the reduction degree. Moreover, in a range of from 250° C. to 600° C., it was understood that the higher the processing temperature is the larger the reduction degree is so that the charge restraining effect is produced greatly.

As set forth in Table 4, when comparing the wafers according to the examples with the wafers according to the comparative examples, wafers which were processed at the same pressure, the bulk resistivity and surface voltage were lowered and the charge neutralizing time was shortened in all of the wafers according to the examples. Moreover, it was confirmed that the transmissivity was also lowered, though it is not listed in Table 4. Thus, as mentioned above, it is understood that the wafers were reduced efficiently by the reducing agent so that the charging was restrained. Moreover, as shown in FIG. 6, the bulk resistivity of wafers were lowered and particularly the reduction of charge neutralizing time was remarkable when the processing pressure was lowered from 133×10⁻¹ to 133×10⁻² Pa. The transmissivity and surface voltage were also lowered similarly. Note that, at 133×10⁻⁷ Pa, the bulk resistivity and the like rose slightly. Thus, in the charge restraining treatment of the present invention, it is possible to control the reduction degree by adjusting the processing pressure. In the present embodiment, it is possible to say that a processing pressure of from 133×10⁻² to 133×10⁻⁶ Pa is suitable.

(2) Charge Restraining Treatment by Second Embodiment

By using the charge restraining apparatus according to the aforementioned second embodiment, charge restraining treatments were carried out under the conditions set forth in Table 5 below. That is, charge restraining treatments, which were carried out at a processing temperature of 550° C. under a processing pressure of 10.5×10⁻¹ Pa but whose processing times were varied, were labeled Example Nos. 31 through 34.

TABLE 5

| | Processing Time (min.) | | | |
|---|---|---|---|---|
| Reducing Agent | 30 | 45 | 60 | 120 |
| Lithium | Ex. #31 | Ex. #32 | Ex. #33 | Ex. #34 |
| Carbonate | | | | |
| Solution | | | | |

*Processing Temp.: 550° C.,
Processing Pressure: 10.5 × 10⁻¹ Pa

Regarding the respective wafers which were charge restrained, the bulk resistivity, the transmissivity, the changes of surface voltage with time, and the charge neutralizing time were measured in the same manner as above (1). In Table 6, there are set forth the measurement results on the wafers, which were subjected to the respective charge restraining treatments according to Example Nos. 31 through 34. Moreover, in FIG. 7, there are illustrated relationships between the processing time and the bulk resistivity as well as the charge neutralizing time.

TABLE 6

| | Ex. #31 | Ex. #32 | Ex. #33 | Ex. #34 |
|---|---|---|---|---|
| Bulk | 1.8 × 10¹¹ | 4.5 × 10¹⁰ | 1.3 × 10¹⁰ | 8.2 × 10⁹ |
| Resistivity | | | | |
| (Ω · cm) | | | | |
| Surface | 0.06 | 0.04 | <0.02 | <0.01 |
| Voltage (kV) | | | | |
| Charge | 2.1 | 0.7 | <0.1 | <0.1 |
| Neutralizing | | | | |
| Time (sec.) | | | | |

As represented in Table 6 and FIG. 7, the longer the processing time was, the more the bulk resistivity and surface voltage of wafers were lowered and the more the charge neutralizing time was shorted. Moreover, it was confirmed that the transmissivity was also lowered, though it is not shown in Table 6 and FIG. 7. Thus, in the charge restraining treatment of the present invention, it is possible to control the reduction degree by adjusting the processing time. In the present embodiment, when the processing time is adapted to be 60 minutes or more, it is understood that the charge restraining effect is produced greatly.

(3) Charge Restrained Wafer

Onto wafers made from an LT single crystal, charge restraining treatments were carried out with various methods set forth below. That is, charging treatments under various conditions as set forth in Table 7 and Table 8 are expressed as Test Sample Nos. 1 through 11.

Test Sample Nos. 1 through 5 are those in which a lithium tantalate single crystal substrate whose Curie temperature was 603° C. and bulk resistivity was 5.0×10¹⁴ Ω·cm was processed in line with a prior-art reducing method.

Test Sample No. 1 is one which was carried out in compliance with Patent Literature No. 1 described in “Description of the Related Art,” and is one in which a hydrogen gas, a reducing gas, was used as the reducing agent. Moreover, Test Sample No. 2 is one which was carried out in compliance with Patent Literature No. 2, and is one in which a technique of diffusing metallic zinc was used. In addition, Test Sample Nos. 3, 4 and 5 are those in which reducing methods, prior arts, were used, respectively.

Test Sample No. 3 is one in which a combined use of a combustible organic gas and a vacuum heat treatment was used. As for the combustible gas, glycerin, a carbon paste, and a carbon-based organic solvent were used.

Test Sample No. 4 is one which was heat treated in high vacuum for a long time, without using a reducing agent. Test Sample No. 5 is one in which a method of contacting highly reactive metal is used. It is one in which a wafer was brought into contact with a metallic lithium bath under ordinary pressure.

Regarding the respective wafers which were charge restrained, the surface-layer Curie temperature, the change of piezoelectricity, the depth of reduced layer, and the variation range of bulk resistivity were measured.

In Table 7, there are set forth the aforementioned reducing conditions in Test Sample Nos. 1 through 5, and the respective measurement results.

TABLE 7

| | Treatment Condition and Measurement Result | | | | | | |
|---|---|---|---|---|---|---|---|
| | | | | Surface- | | | |
| | | | | layer Curie | | | |
| | | | | Temp. (° C.) | | | |
| | | | | In ( ), | | | |
| | | | | difference | | | Variation |
| | | Vacuum | | from | | Reduced- | Range of |
| | | Degree | | Before- | Change of | layer | Bulk |
| | Reducing | (torr)/ | | treatment is | Piezoelectric | Depth | Resistivity |
| | Agent | Temp. (° C.) | Time (H) | designated. | Characteristic | (μm) | (Ω · cm) |
| Test Sample | H2 Gas | Ordinary | 48 | 599.4 | Changed | 3 | 10¹³-10¹⁴ |
| No. 1 | | Pressure | | (−3.6) | | | |
| | | 590 | | | | | |
| Test Sample | Metallic | Ordinary | 300 | 606.5 | Changed | 40 | 10¹²-10¹⁴ |
| No. 2 | Zinc | Pressure | | (+3.5) | | | |
| | | 590 | | | | | |
| Test Sample | Glycerin, | 10⁻² | 100 | 596.5 | Changed | 6 | 10¹³-10¹⁴ |
| No. 3 | Carbon Paste | 590 | | (−6.5) | | | |
| | & Carbon- | | | | | | |
| | based | | | | | | |
| | Organic | | | | | | |
| | Solvent | | | | | | |
| Test Sample | None | 10⁻⁷ | 48 | 585.8 | Changed | 7 | 10¹³-10¹⁴ |
| No. 4 | | 590 | | (−17.2) | | | |
| Test Sample | Metallic Na | Ordinary | 1 | Structurally | Characteristic | — | 10⁵-10⁷ |
| No. 5 | Liquid | Pressure | | Broken by | Degraded | | |
| | | 200 | | Blackening | | | |

*Before-treatment Specimen: Surface-layer Curie Temp.; 603° C., and Bulk Resistivity; 5.0 × 10¹⁴ Ω · cm

The Curie temperature was measured using a differential thermal analyzer (“TG-DTA THERMAL ANALYSIS STATION TAS100” made by RIGAKU Corp.). The change of the piezoelectric characteristic was judged by the change of Curie temperature. That is, those whose Curie temperature changed were referred to as those whose piezoelectric characteristic changed. The measurement of reduced layer depth was such that the specimens were first scraped away by polishing manually by from 1 to 2 μm from the surfaces with a glass plate and grinding abrasive grains and the bulk resistivity was measured every time therewith. The specimens' thickness, at which the aforementioned bulk resistivity became the before-reducing-treatment bulk resistivity, was measured with a micrometer, and a thickness from the scraped-away surface was calculated to regard it as the reduced-layer depth. The variation range of bulk resistivity resulting from the treatments was such that the range of changing bulk resistivity by carrying out the respective treatments was represented with digit numbers.

Test Sample Nos. 6 through 11 are those in which charge restraining treatments whose reducing agents, vacuum degrees and processing times were altered were carried out, using a lithium tantalate single crystal substrate whose Curie temperature was 603° C. and bulk resistivity was 5.0×10¹⁴ Ω·cm and the aforementioned first embodiment.

Regarding the respective wafers which were charge restrained, the color of 20-μm surface layer, the internal color, the Curie temperature at 20-μm surface layer, the internal Curie temperature, the existence or nonexistence of Li diffusion in surface composition, the after-treatment bulk resistivity, and the consumption trend of reducing agent were measured.

In Table 8, there are set forth the aforementioned reducing conditions in Test Sample Nos. 6 through 11, and the respective measurement results.

TABLE 8

| | Treatment Condition and Measurement Result | | | | | | | |
|---|---|---|---|---|---|---|---|---|
| | | | | | | Existence | | |
| | | | | | | or | | |
| | | | | | | Non- | | |
| | | | | | 20-μm | existence | | |
| | | | | 20-μm | Surface- | of | After- | |
| | | Vacuum | | Surface- | layer/ | Li | treatment | Consumption |
| | | Degree | | layer | Internal | Diffusion | Bulk | Trend of |
| | Reducing | (torr)/ | | Color/Internal | Curie | in Surface | Resistivity | Reducing |
| | Agent | Temp. (° C.) | Time (H) | Color | Temp. (° C.) | Composition | (Ω · cm) | Agent |
| Test Sample | None | 10⁻⁷ | 24 | Light | 589.5/ | With Li | 10¹³-10¹⁴ | — |
| No. 6 | | 590 | | Gray/ | 603.0 | Outward | | |
| | | | | White | | Diffusion | | |
| | | | | | | (Surface | | |
| | | | | | | Polarization | | |
| | | | | | | Breakage) | | |
| Test Sample | None/N₂ Gas | Ordinary | 24 | White/ | 603.2/ | Without | 3.0 × 10¹⁴ | — |
| No. 7 | | Pressure | | White | 603.0 | Both Li | | |
| | | 590 | | | | Inward | | |
| | | | | | | Diffusion | | |
| | | | | | | and Outward | | |
| | | | | | | Diffusion | | |
| Test Sample | LiCl/N₂ Gas | Ordinary | 24 | White/ | 603.0/ | Without | 3.0 × 10¹⁴ | — |
| No. 8 | | Pressure | | White | 603.2 | Both Li | | |
| | | 590 | | | | Inward | | |
| | | | | | | Diffusion | | |
| | | | | | | and Outward | | |
| | | | | | | Diffusion | | |
| Test Sample | 25 g LiCl | 10⁻² | 24 | Light | 603.0/ | Without | 2.0 × 10¹² | 2.5 g/hr |
| No. 9 | | 590 | | Gray/ | 603.1 | Both Li | | Consumption |
| | | | | Light | | Inward | | Rate; |
| | | | | Gray | | Diffusion | | Without |
| | | | | | | and Outward | | Residual |
| | | | | | | Diffusion | | Reducing |
| | | | | | | | | Agent after |
| | | | | | | | | Treatment |
| Test Sample | 100 g LiCl | 10⁻² | 24 | Gray/ | 603.1/ | Without | 3.0 × 10¹¹ | 2.5 g/hr |
| No. 10 | | 590 | | Gray | 603.0 | Both Li | | Consumption |
| | | | | | | Inward | | Rate; |
| | | | | | | Diffusion | | 40 g Residual |
| | | | | | | and Outward | | Reducing |
| | | | | | | Diffusion | | Agent after |
| | | | | | | | | Treatment |
| Test Sample | 150 g LiCl | 10⁻³ | 24 | Dark | 603.0/ | Without | 2.0 × 10¹¹ | 3.0 g/hr |
| No. 11 | | 590 | | Gray/ | 603.1 | Both Li | | Consumption |
| | | | | Dark | | Inward | | Rate; |
| | | | | Gray | | Diffusion | | 78 g Residual |
| | | | | | | and Outward | | Redusing |
| | | | | | | Diffusion | | Agent after |
| | | | | | | | | Treatment |

*Before-treatment Specimen: Surface-layer Curie Temp.; 603° C., and Bulk Resistivity; 5.0 × 10¹⁴ Ω · cm

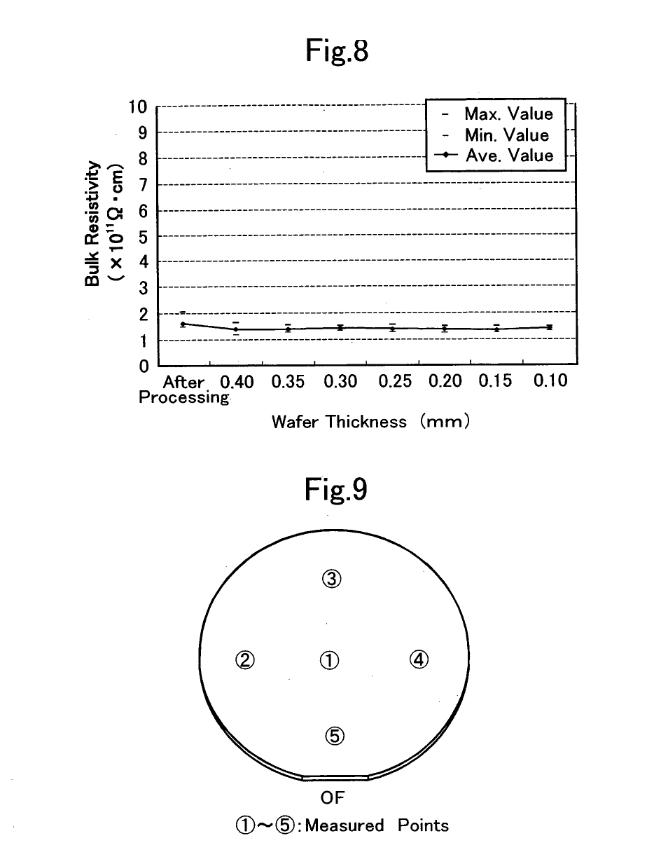

Note that the depth-wise bulk resistivity was measured using the after-treatment wafers according to Test Sample No. 10. Both top and bottom sides were scraped off by 50 μm from the thickness of the after-treatment wafers, and the measurement of bulk resistivity was carried out. This was carried out repeatedly to process them to a substrate thickness of 100 μm, and the measurement of bulk resistivity was carried out. In FIG. 8, there is illustrated a change of bulk resistivity in the wafers' thickness direction.

Moreover, the fluctuation of in-plane transmissivity was measured using the after-treatment wafers according to Test Sample No. 10 similarly. The after-treatment wafers were mirror finished to a thickness of 0.35 mm on the both surfaces, and the transmissivity for a wavelength of 365 nm was measured. In FIG. 9, there are illustrated transmissivity measurement points on the wafers. In Table 9, there are set forth the measurement results of transmissivity.

TABLE 9

| Measurement Point | T (%), 365 nm |
|---|---|
| \textcircled{1} | 65.43 |
| \textcircled{2} | 66.31 |
| \textcircled{3} | 65.83 |
| \textcircled{4} | 65.17 |
| \textcircled{5} | 66.13 |
| MAX. | 66.31 |
| MIN. | 65.17 |
| R. | 1.14 |

The Curie temperature was measured using a differential thermal analyzer in the same manner as described above.

The bulk resistivity was measured by the same method as aforementioned (1).

The color measurement was carried out visually. The color designations were expressed according to “JIS Standard Chroma,” a color sample table based on the Munsell hue ring.

The existence or non-existence of Li diffusion in surface composition was judged from the change of Curie temperature. When the Curie temperature decreased, it was judged that Li outward diffusion was present, and, when the Curie temperature increased, it was judged that Li inward diffusion was present.

The consumption trend of reducing agent was found by a calculation resulting from how much reducing agent remained after the treatment. Note that the consumption trend of reducing agent in Test Sample No. 9 was calculated from the residual amount of reducing agent in Test Sample No. 10.

The transmissivity was measured using an ultraviolet-visible light spectrophotometer (“V570” made by NIHON BUNKOU Co., Ltd.) in the same manner as (1).

As set forth in Table 7, Test Sample Nos. 1 through 4 are such that the reduction reaction occurs in the surface layer alone. Moreover, the variation range of bulk resistivity is two digits approximately, at the highest. A processing time, which is unendurable for practical application, is required in order to keep processing until changing it to the objective bulk resistivity, from 1.0×10¹⁰ Ω·cm or more to 9.0×10¹² Ω·cm or less.

Moreover, it is understood that Test Sample Nos. 1 through 4 are such that the Curie temperature changes by ±3° C. or more compared with that before the reduction treatment. The deterioration of Curie temperature is judged that the deterioration of surface lithium concentration occurs. In addition, the rise of Curie temperature is believed to result from the diffusion of different kinds of metals.

During the treatment, the processing temperature exceeding the Curie temperature breaks down the material's own polarization so that the piezoelectric characteristic is not exhibited. In particular, as an LT single crystal whose Curie temperature is low is processed around the Curie temperature for a long period of time, it is believed probable that, when the Curie temperature of material lowers, the processing temperature goes beyond its Curie temperature. Therefore, in case of processing an LT single crystal especially, the lowered Curie temperature by a reduction treatment results in a possibility of breaking down the material's own polarization.

Moreover, as set forth in Table 7, Test Sample No. 5 is one in which it is brought into contact with a metal of high reactivity under ordinary pressure, however, it is a rapid reaction so that structural breakdown is caused by blackening. Moreover, the piezoelectric characteristic is degraded as well. In addition, since the bulk resistivity (Ω·cm) exhibits a digit of from 10⁵ to 10⁷, the bulk resistivity is lowered so much that it cannot be provided for practical use.

Contrary to Test Sample Nos. 1 through 5, as set forth in Table 8, Test Sample Nos. 7 through 11 are such that the surface and internal Curie temperatures do not change at all from the before-treatment Curie temperature.

However, Test Sample Nos. 7 and 8 are such that the surface and internal colors of the after-treatment wafers were white and their bulk resistivity hardly changed. Test Sample Nos. 7 and 8 are believed that they are not subjected to the reduction treatment at all.

Test Sample No. 6 is such that the surface-layer Curie temperature decreased lower than the processing temperature so that the surface layer causes polarization breakdown. Since the surface-layer bulk resistivity (Ω·cm) exhibits a digit of from 10¹³ to 10¹⁴, it does not reach the aiming bulk resistivity. Since the outward diffusion of lithium occurs in the surface composition, it is believed that the lithium concentration lowers so that the surface-layer Curie temperature has lowered.

Test Sample Nos. 9, 10 and 11 are such that the surface and internal Curie temperatures do not change at all from the before-treatment Curie temperature, and since the bulk resistivity (Ω·cm) exhibits digits of 10¹² and 10¹⁰, it falls in the aiming bulk resistivity range.

Test Sample No. 9 is such that the reducing agent did not remain at all after the treatment. When calculating it from Test Sample No. 10 in which only the reducing agent amount was increased under the same condition, Test Sample No. 9 is such that the reducing agent amount is less, and it is believed that the reducing agent has been consumed completely within the processing time. When calculating the continuous processing time of reducing agent from the remaining reducing agent in Test Sample No. 10, it is believed to be 10 hours out of the 24-hour processing time.

On the other hand, since Test Sample No. 10 is such that the reducing agent remains after the treatment, it designates that the reduction was carried out continuously during the processing time.

Moreover, Test Sample No. 11 is such that the treatment was carried out in higher vacuum than that in Test Sample Nos. 9 and 10. When calculating the consumption rate of reducing agent from the remaining reducing agent, it becomes faster compared with that in Test Sample No. 10. In addition, since the reducing agent remained after the treatment, similarly to Test Sample No. 10, it designates that the reduction was carried out continuously during the processing time.

When comparing Test Sample Nos. 9, 10 and 11, the bulk resistivity lowers by every one digit. Moreover, since there is no difference between the surface and internal colors in all of Test Sample Nos. 9, 10 and 11, it is understood that they are reduced uniformly down to their insides. In addition, the hue deepens gradually in the order of Test Sample Nos. 9, 10 and 11, it is understood that the reduction degree intensifies gradually, when thinking this along with the values of bulk resistivity as well. From this, it is understood that the reduction degree can be controlled to required values, depending on the amount of reducing agent, the vacuum degree, the temperature, the processing time, and the like.

According to FIG. 8 which illustrates the thickness-wise change of bulk resistivity which was carried out using this Test Sample No. 10, no thickness-wise bulk-resistivity change was observed until cutting it to 0.10 mm from a 0.45-mm after-treatment wafer thickness. From this, it is understood that it is reduced uniformly from the surface to the inside.

Moreover, according to Table 9 which sets forth the measurement results of transmissivity, the wafer whose before-treatment transmissivity was 72±1% for a wavelength of 365 nm was such that the after-treatment transmissivity becomes 65%. The reduced wafer was such that its color, which has been white before the treatment, comes to show gray. That is, as the reduction develops, the transmissivity lowers.

Moreover, in order to observe the fluctuation of in-plane transmissivity, the transmissivity was measured at 5 places in a plane as illustrated in FIG. 9. As set forth in Table 9, the fluctuation was 1.1%, and did not change from the fluctuation of before-treatment transmissivity. From this, it is understood that the reduction treatment is carried out uniformly within the plane as well.

As being observed in Test Sample Nos. 9, 10 and 11, it was possible to confirm a charge restrained lithium tantalate single crystal whose surface-layer Curie temperature of charge restrained wafer does not change from that before the treatment and whose bulk resistivity is from 1.0×10¹⁰ Ω·cm or more to 9.0×10¹² Ω·cm or less at the superficial portion and central portion.

1. A charge restrained wafer exhibiting a bulk resistivity of from 1.0×10¹⁰ Ω·cm or more to 9.0×10¹² Ω·cm or less at a superficial portion and a central portion, and made from a lithium tantalate single crystal or a lithium niobate single crystal.

2. The charge restrained wafer set forth in claim 1, being characterized in that a change in Curie temperatures at a superficial layer of the wafer before a charge restraining process and after the process falls within ±3° C.

3. The charge restrained wafer set forth in claim 1, being characterized in that a Curie temperature difference between a superficial layer of the charge restrained wafer and an inner part thereof falls within ±3° C.

4. A method for charge restraining a piezoelectric oxide single crystal, being characterized in that it comprises:
accommodating a wafer, made from a lithium tantalate single crystal or a lithium niobate single crystal, and a reducing agent, including an alkali metal or an alkali metal compound, in a processing apparatus; and
reducing the wafer by holding the inside of the processing apparatus at a temperature of from 200° C. or more to less than a Curie temperature of the single crystal under decompression.

5. The method for charge restraining a piezoelectric oxide single crystal set forth in claim 4, wherein the reduction of the wafer is carried out under decompression of from 133×10⁻¹ to 133×10⁻⁷ Pa.

6. The method for charge restraining a piezoelectric oxide single crystal set forth in claim 4, wherein the alkali metal or alkali metal compound is metallic lithium or a lithium compound.

7. The method for charge restraining a piezoelectric oxide single crystal set forth in claim 4, wherein the reducing agent comprises the alkali metal or the alkali metal compound; and the reduction of the wafer is carried out by disposing the reducing agent and the wafer separately, or by burying the wafer in the reducing agent.

8. The method for charge restraining a piezoelectric oxide single crystal set forth in claim 4, wherein the reducing agent is an alkali metal solution or an alkali metal compound solution in which the alkali metal or the alkali metal compound is dissolved or dispersed in a solvent; and
the reduction of the wafer is carried out by disposing the reducing agent and the wafer separately, or by immersing the wafer into the reducing agent, or by painting the reducing agent onto a surface of the wafer.

9. A charge restraining apparatus for a piezoelectric oxide single crystal, comprising:
a processing tank for accommodating a wafer, made from a lithium tantalate single crystal or a lithium niobate single crystal, and a reducing agent, including an alkali metal or an alkali metal compound, therein;
means for heating the inside of the processing tank to a temperature of from 200° C. or more to less than a Curie temperature of the single crystal; and
means for decompressing the inside of the processing tank.
